(19) United States
(12) Patent Application Publication
(10) Pub. No.: US 2021/0392850 A1
(43) Pub. Date: Dec. 23, 2021

(54) MULTIFUNCTIONAL NURSING OBSTETRIC TABLE FOR CAT

(71) Applicants: Lintian YU, Nanning City (CN); Xiaoyan XIONG, Nanning City (CN); Zhenbin QIN, Nanning City (CN)

(72) Inventors: Lintian YU, Nanning City (CN); Xiaoyan XIONG, Nanning City (CN); Zhenbin QIN, Nanning City (CN)

(21) Appl. No.: 17/131,005

(22) Filed: Dec. 22, 2020

(30) Foreign Application Priority Data
Jun. 17, 2020 (CN) 202010553913.1

(51) Int. Cl. A01K 1/035; A01K 1/01

(52) U.S. Cl. CPC A01K 1/035; A01K 1/0107

(57) ABSTRACT

The present disclosure discloses a multifunctional nursing obstetric table for a cat. The table includes a table body. A foot stand is arranged on the lower side of the table body. A cat litter tank is arranged in the center of the foot stand. One end of the cat litter tank penetrates out of the foot stand, and the other end of the cat litter tank is fixedly connected to the foot stand through connecting rods. A bracket is arranged at one end of the table body. The lower end of the bracket is fixedly connected to the table body. A heat insulating piece used for maintaining a temperature is arranged at the upper end of the bracket. The heat insulating piece is rotatably connected to the bracket through a rotating shaft. A first recessed portion is formed in one end, close to the bracket, of the table body.

### TECHNICAL FIELD

The present disclosure relates to the technical field of equipment for pet cats, and in particular, to a multifunctional nursing obstetric table for a cat.

### BACKGROUND

With the improvement of people's living standards, pets appear more and more in people's life and are also treated as members of a family Dogs and cats have the largest numbers in numerous pets, which shows that the dogs and cats are becoming more and more popular. Particularly, the feeding number of cats has increased most rapidly in recent years. The reason why the cats become people's new favorites has an inseparable relationship with their own advantages. As pets, the cats have smaller sizes, eat less, and are easier to feed and lower in cost compared with the dogs. No matter in terms of management or space, the cats are easier to manage, need smaller feeding management space, and particularly, are more suitable for the house types with smaller living areas. The cats' habits are more gentle and are not as aggressive and threatening as the dogs, so the friendly cats certainly become the first choice of people.

With the increase of the feeding number of pet cats, feeding and breeding of the pet cats have become a matter of concern. At present, the used cat obstetric tables those sold on the market or made by people themselves are relatively simple and have a single function. There is no special obstetric and nursery table for the cats at present, so there are many adverse effects on the breeding of the pet cats and the management of baby cats.

### SUMMARY

The objective of the present disclosure is to provide a multifunctional nursing obstetric table for a cat. The multifunctional nursing obstetric table for the cat provided by the present disclosure combines cat childbirth and baby cat nursing, which makes cat feeding and management become more convenient and efficient. In addition, mother cats and baby cats are healthier and easier to keep. The technical solution adopted by the present disclosure is as follows:

According to one aspect of the present disclosure, a multifunctional nursing obstetric table for a cat is provided. The multifunctional nursing obstetric table for the cat includes a table body. A foot stand is arranged on the lower side of the table body. The upper end of the foot stand is fixedly connected to the lower end of the table body. A cat litter tank is arranged in the center of the foot stand. One end of the cat litter tank penetrates out of the foot stand, and the other end of the cat litter tank is fixedly connected to the foot stand through connecting rods. A bracket is arranged at one end of the table body. The lower end of the bracket is fixedly connected to the table body. A heat insulating piece used for maintaining a temperature is arranged at the upper end of the bracket. The heat insulating piece is rotatably connected to the bracket through a rotating shaft. A first recessed portion is formed in one end, close to the bracket, of the table body. A drawer is arranged at the other end of the table body. Second recessed portions are formed in the upper side of the drawer.

Preferably, universal wheels are arranged at the lower end of the foot stand. The upper ends of the universal wheels are fixedly connected to the foot stand.

Preferably, the foot stand includes four vertical rods and four cross rods. The upper ends of the four rods are respectively and fixedly connected to the four corners of the table body. Each of the cross rods is fixedly connected between two adjacent vertical rods.

Preferably, the left end of the cat litter tank is erected on a cross rod. The bottom of the cat litter tank is arranged as a sloping structure with a low front side and a high rear side. A cleaning mouth is formed in the front side of the right end of the cat litter tank. A baffle piece is arranged on the cleaning mouth. The baffle piece is hinged to the cat litter tank.

Preferably, the bracket includes two telescopic rods and a fixed rod. The lower ends of the two telescopic rods are respectively and fixedly connected to the table body. The upper ends of the two telescopic rods are connected through the fixed rod.

Preferably, the heat insulating piece includes a housing and a heating tube. One end of the housing is rotatably connected to the fixed rod through the rotating shaft. The heating tube is fixedly connected to the interior of the housing.

Preferably, an LED lamp tube is arranged on the lower side of the housing. The LED lamp tube is fixedly connected to the outer wall of the lower side of the housing. An ultraviolet lamp tube is arranged on the lower side of the housing, and is located in front of the LED lamp tube. The ultraviolet lamp tube is fixedly connected to the housing.

Preferably, a cotton mat is laid in the first recessed portion. The cotton mat is fixedly adhered to the interior of the first recessed portion.

The technical solution adopted by the present disclosure has the following remarkable effects that:

According to the multifunctional nursing obstetric table for the cat provided by the present disclosure, a foot stand is arranged on the lower side of the table body. Universal wheels are arranged at the lower end of the foot stand. The universal wheels make the nursing obstetric table be capable of moving in any direction. A cat litter tank is arranged in the center of the foot stand. One end of the cat litter tank penetrates out of the foot stand, and the other end of the cat litter tank is fixedly connected to the foot stand through connecting rods. Cat litter is laid in the cat litter tank, which facilitates providing a place for a cat to relieve the bowels. The bottom of the cat litter tank is arranged as a sloping structure with a low front side and a high rear side. A cleaning mouth is formed in the front side of the cat litter tank. The sloping structure facilitates rolling of contaminated cat litter to a front side, and then cleaning through the cleaning mouth. A bracket is arranged at one end of the table body. A heat insulating piece used for maintaining a temperature is arranged at the upper end of the bracket. The heat insulating piece is used for maintaining the environment around the nursing obstetric table at a certain temperature. A first recessed portion is formed in one end of the table body. The first recessed portion is a place for the mother cat and the baby cat to have a rest. A drawer is arranged at the other end of the table body. Second recessed portions are formed in the upper side of the drawer. The drawer is used for storing some cleaning tools and cat food. The second recessed portions are used for holding cat food and a phagostimulant. The multifunctional nursing obstetric table for the cat combines cat childbirth and baby cat nursing, which makes cat feeding and management become more convenient and efficient. In addition, a mother cat and a baby cat are healthier and easier to keep.

### BRIEF DESCRIPTION OF THE DRAWINGS

FIG. 1 is a schematic structural diagram of a multifunctional nursing obstetric table for a cat of the present disclosure.

In the drawings: 1-table body; 2-foot stand; 3-cat litter tank; 4-connecting rod; 5-cleaning mouth; 6-baffle piece; 7-bracket; 8-heat insulating piece; 9-first recessed portion; 10-cotton mat; 11-drawer; 12-second recessed portion; 21-vertical rod; 22-cross rod; 23-universal wheel; 71-telescopic rod; 72-fixed rod; 81-housing; 82-heating tube; 83-rotating shaft; 84-LED lamp tube; 85-ultraviolet lamp tube.

### DETAILED DESCRIPTION

In order to make the purpose, technical solution and advantages of the present disclosure clearer, the present disclosure will be further described in detail below with reference to the accompanying drawings and embodiments. However, it should be noted that many details listed in the specification are only intended to give a reader a thorough understanding of one or more aspects of the present disclosure. These aspects of the present disclosure can also be realized even without these specific details.

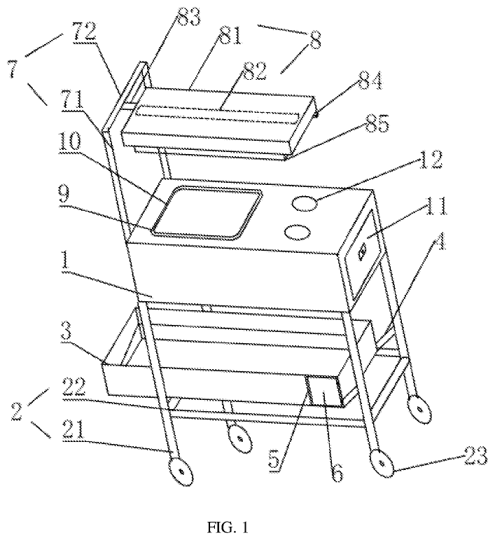

As shown in FIG. 1, a multifunctional nursing obstetric table for a cat according to the present disclosure includes a table body 1. A foot stand 2 is arranged on the lower side of the table body 1. The foot stand 2 includes four vertical rods 21 and four cross rods 22. The upper ends of the four vertical rods 21 are respectively and fixedly connected to the four corners of the table body 1. Each of the cross rods 22 is fixedly connected between two adjacent vertical rods 21. In addition, an accommodating space is formed among the cross rods 22, the vertical rods 21, and the table body 1. A universal wheel 23 is arranged at the lower end of each of the vertical rods 21. The upper end of each universal wheel 23 is fixedly connected to corresponding vertical rod 21. The vertical rods 21 and the cross rods 22 serve as support parts, and are used for supporting the table body 1. The universal wheels 23 at the lower ends of the vertical rods 21 may facilitate the movement of the table body 1. A cat litter tank 3 is arranged in the accommodating space formed by the cross rods 22, the vertical rods 21, and the table body 1. The left end of the cat litter tank 3 is erected on a cross rod 22. The front side and the rear side of the right end of the cat litter tank 3 are fixedly connected to the vertical rods 21 through connecting rods 4. The bottom of the cat litter tank 3 is arranged as a sloping structure with a low front side and a high rear side. A cleaning mouth 5 is formed in the front side of the right end of the cat litter tank 3. A baffle piece 6 is arranged on the cleaning mouth 5. The baffle piece 6 is hinged to the cat litter tank 3. The cat litter tank 3 contains cat litter, so a cat may relieve the bowels in the cat litter tank 3. The sloping structure facilitates rolling of contaminated cat litter to a front side, and cleaning by an owner through the cleaning mouth.

A bracket 7 is arranged at one end of the table body 1. The bracket 7 includes two telescopic rods 71 and a fixed rod 72. The telescopic rods 71 are in the prior art. The lower ends of the two telescopic rods 71 are respectively and fixedly connected to the front side and the rear side of the left end of the table body 1. The upper ends of the two telescopic rods 71 are connected through the fixed rod 72. A heat insulating piece 8 used for maintaining a temperature is arranged at the upper ends of the telescopic rods 71. The heat insulating piece 8 includes a housing 81 and a heating tube 82. One end of the housing 81 is rotatably connected to the fixed rod 72 through a rotating shaft 83. The heating tube 82 is fixedly connected to the interior of the housing 81. An LED lamp tube 84 is arranged on the lower side of the housing 81. The LED lamp tube 84 is fixedly connected to the outer wall of the lower side of the housing 81. An ultraviolet lamp tube 85 is arranged on the lower side of the housing 81, and is located in front of the LED lamp tube 84. The ultraviolet lamp tube 85 is fixedly connected to the housing 81. The heating tube 82 can maintain the temperature of a surrounding environment at a certain temperature, so as to provide a proper temperature for the cat and a baby cat. The LED lamp tube 84 may provide light for the owner to observe situations. The ultraviolet lamp tube 85 can disinfect and sterilize, so as to provide a safe and comfortable environment for the cat and the baby cat.

A first recessed portion 9 is formed in one end, close to the telescopic rods 71, of the table body 1. The first recessed portion 9 is passivated, and is used for the cat and the baby cat to have a rest. A cotton mat 10 is laid in the first recessed portion 9. The cotton mat 10 is fixedly adhered to the interior of the first recessed portion 9, so that the cat and the baby cat feel comfortable in the first recessed portion 9. A drawer 11 is arranged at one end, far away from the first recessed portion 9, of the table body 1. The drawer 11 is used for storing some tools and cat food. Two second recessed portions 12 are formed in the upper side of the drawer 11. The two second recessed portions 12 are arranged side by side. One of the second recessed portions 12 is used for holding the cat food, and the second one is used for holding a phagostimulant used for phagostimulating the baby cat.

When the multifunctional nursing obstetric table for the cat is used, first, the cat is placed in the first recessed portion 9, then, the heating tube 82 is turned on, so that the heating tube 82 works, next, the cat litter is laid in the cat litter tank 3, and the cat food and the phagostimulant are placed in the second recessed portions 12. After the cat relieves the bowels in the cat litter, the contaminated cat litter may be treated through the cleaning mouth 5 by opening the baffle piece 6.

The foregoing descriptions are merely preferred embodiments of the present disclosure. It should be noted that those of ordinary skill in the art may make several improvements or refinements without departing from the principle of the present disclosure and the improvements or refinements shall also fall within the protection scope of the present disclosure.

What is claimed is:

1. A multifunctional nursing obstetric table for a cat, comprising a table body; a foot stand is arranged on the lower side of the table body; the upper end of the foot stand is fixedly connected to the lower end of the table body; a cat litter tank is arranged in the center of the foot stand; one end of the cat litter tank penetrates out of the foot stand, and the other end of the cat litter tank is fixedly connected to the foot stand through connecting rods; a bracket is arranged at one end of the table body; the lower end of the bracket is fixedly connected to the table body; a heat insulating piece used for maintaining a temperature is arranged at the upper end of the bracket; the heat insulating piece is rotatably connected to the bracket through a rotating shaft; a first recessed portion is formed in one end, close to the bracket, of the table body; a drawer is arranged at the other end of the table body; second recessed portions are formed in the upper side of the drawer.

2. The multifunctional nursing obstetric table for the cat according to claim 1, wherein universal wheels are arranged at the lower end of the foot stand; the upper ends of the universal wheels are fixedly connected to the foot stand.

3. The multifunctional nursing obstetric table for the cat according to claim 1, wherein the foot stand comprises four vertical rods and four cross rods; the upper ends of the four vertical rods are respectively and fixedly connected to the four corners of the table body; each of the cross rods is fixedly connected between two adjacent vertical rods.

4. The multifunctional nursing obstetric table for the cat according to claim 1, wherein the left end of the cat litter tank is erected on a cross rod; the bottom of the cat litter tank is arranged as a sloping structure with a low front side and a high rear side; a cleaning mouth is formed in the front side of the right end of the cat litter tank; a baffle piece is arranged on the cleaning mouth; the baffle piece is hinged to the cat litter tank.

5. The multifunctional nursing obstetric table for the cat according to claim 1, wherein the bracket comprises two telescopic rods and a fixed rod; the lower ends of the two telescopic rods are respectively and fixedly connected to the table body; the upper ends of the two telescopic rods are connected through the fixed rod.

6. The multifunctional nursing obstetric table for the cat according to claim 5, wherein the heat insulating piece comprises a housing and a heating tube; one end of the housing is rotatably connected to the fixed rod through the rotating shaft; the heating tube is fixedly connected to the interior of the housing.

7. The multifunctional nursing obstetric table for the cat according to claim 6, wherein an LED lamp tube is arranged on the lower side of the housing; the LED lamp tube is fixedly connected to the outer wall of the lower side of the housing; an ultraviolet lamp tube is arranged on the lower side of the housing, and is located in front of the LED lamp tube; the ultraviolet lamp tube is fixedly connected to the housing.

8. The multifunctional nursing obstetric table for the cat according to claim 1, wherein a cotton mat is laid in the first recessed portion; the cotton mat is fixedly adhered to the interior of the first recessed portion.
